(19) United States
(12) Patent Application Publication
(10) Pub. No.: US 2013/0039054 A1
(43) Pub. Date: Feb. 14, 2013

(54) LIGHT-EMITTING DIODE LAMP

(71) Applicants: SUNG-HSIANG YANG, Chu-Nan (TW); CHAO-HUAN CHAO, Chu-Nan (TW)

(72) Inventors: SUNG-HSIANG YANG, Chu-Nan (TW); CHAO-HUAN CHAO, Chu-Nan (TW)

(73) Assignee: FOXSEMICON INTEGRATED TECHNOLOGY, INC., Chu-Nan (TW)

(21) Appl. No.: 13/334,281

(22) Filed: Dec. 22, 2011

(30) Foreign Application Priority Data
Aug. 9, 2011 (TW) 100128313

(51) Int. Cl. F21V 29/00; F21V 5/04; F21V 1/00

(52) U.S. Cl. 362/234; 362/235; 362/244; 362/311.02

(57) ABSTRACT

A light-emitting diode lamp comprises a supporting salver comprising a first and second surfaces, the second surface defines first recesses; light-emitting diodes (LEDs) mounted on the first surface; a lampshade covering the light-emitting diodes, the lampshade comprising an optic portion facing the LEDs, the optic portion comprising lenses, each of the lenses facing each of the LEDs, the lampshade defining second recesses corresponding to the first recesses, each of the first recesses aligned with each of the second recesses; and clips each comprising a connecting portion and two buckling portions at two opposite ends of the connecting portion, the connecting portion being resilient, one of the two buckling portions being received in one of the first recesses, another one of the two buckling portions being received in a corresponding one of the second recesses, wherein the lampshade is interchangeably mounted on the supporting salver through the clips.

### BACKGROUND

1. Technical Field

The present disclosure generally relates to illuminating apparatus, and particularly to a light-emitting diode lamp having an improved adaptability.

2. Description of Related Art

light-emitting diodes (LEDs), available since the early 1960's and, because of their high light-emitting efficiency and long life span, have been increasingly used. According to Illuminating Engineering Society of North America (IESNA), illumination distribution of lighting used in certain locations, such as squares, sidewalks, yards, parks, or parking lots, must meet the standards of Type IV or Type V. These two types of standards require that the light illuminating on the locations has a circular or square pattern, in which the light source is located at a center of the pattern. However, light directly emitted from the LEDs usually cannot meet such a requirement. To meet the requirement, lenses capable of modulating light distribution of the LEDs may be used.

The lens is generally mounted on the LED through screw or glue and not readily to be removed from the LED. Therefore, once the lens is mounted on LED, the light distribution of the LED is fixed. Different LED lamps with different lenses may be required to meet different requirements of light distribution patterns. As a result, additional manufacturing processes and added cost may be required.

What is needed, therefore, is an LED lamp which can overcome the disadvantages as described above.

### BRIEF DESCRIPTION OF THE DRAWINGS

FIG. 1 is an isometric, assembled view of an LED lamp in accordance with a first embodiment of the present disclosure.

FIG. 2 is an exploded view of the LED lamp of FIG. 1.

FIG. 3 is a bottom view of a supporting salver of the LED lamp of FIG. 1.

FIG. 4 is a top view of a lampshade of the LED lamp of FIG. 1.

FIG. 5 is a cross-sectional view of the lampshade of FIG. 4, taken along line IV-IV thereof.

FIG. 6 is a cross-sectional view of the lampshade of FIG. 4, taken along line V-V thereof.

FIG. 7 is a bottom view of the lampshade of FIG. 1.

FIG. 8 is a top view of a lampshade of an LED lamp in accordance with a second embodiment of the present disclosure.

FIG. 9 is a cross-sectional view of the lampshade of FIG. 8, taken along line VIII-VIII thereof.

FIG. 10 is a cross-sectional view of the lampshade of FIG. 8, taken along line IX-IX thereof.

FIG. 11 is a bottom view of the lampshade of the LED lamp of FIG. 8.

FIG. 12 is a top view of a lampshade of an LED lamp in accordance with a third embodiment of the present disclosure.

FIG. 13 is a cross-sectional view of the lampshade of FIG. 12, taken along line XII-XII thereof.

FIG. 14 is a cross-sectional view of the lampshade of FIG. 12, taken along line XIII-XIII thereof.

FIG. 15 is a bottom view of the lampshade of the LED lamp of FIG. 12.

FIG. 16 is a top view of a lampshade of an LED lamp in accordance with a fourth embodiment of the present disclosure.

FIG. 17 is a cross-sectional view of the lampshade of FIG. 16, taken along line XVI-XVI thereof.

FIG. 18 is a cross sectional view of the lampshade of FIG. 16, taken along line VXII-VXII thereof.

FIG. 19 is a bottom view of the lampshade of the LED lamp of FIG. 16.

FIG. 20 is a top view of a lampshade of an LED lamp in accordance with a fifth embodiment of the present disclosure.

FIG. 21 is a cross-sectional view of the lampshade of FIG. 20, taken along line XX-XX thereof.

FIG. 22 is a cross sectional view of the lampshade of FIG. 20, taken along line XXI-XXI thereof.

FIG. 23 is a bottom view of the lampshade of the LED lamp of FIG. 20.

### DETAILED DESCRIPTION

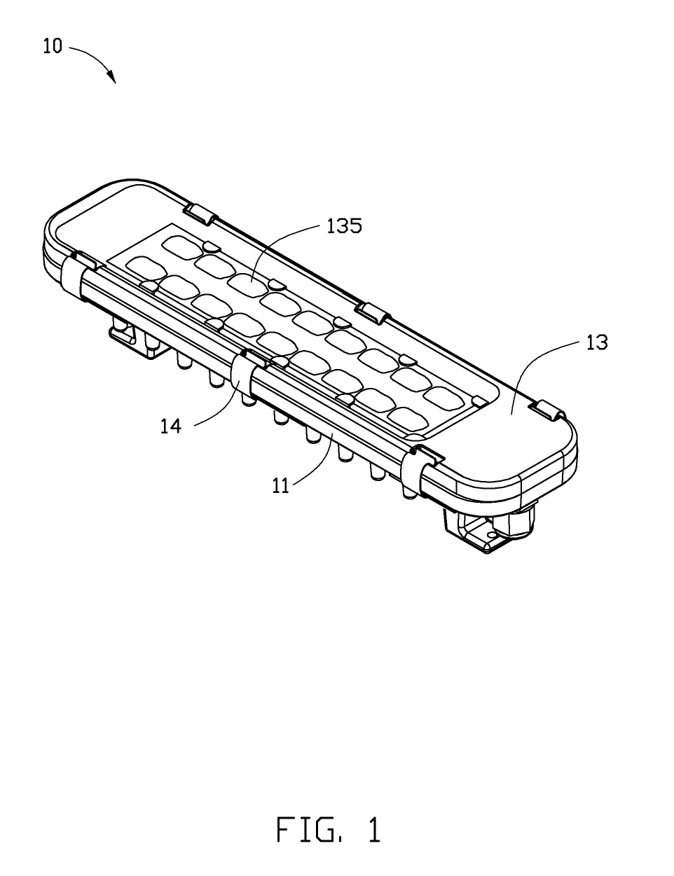

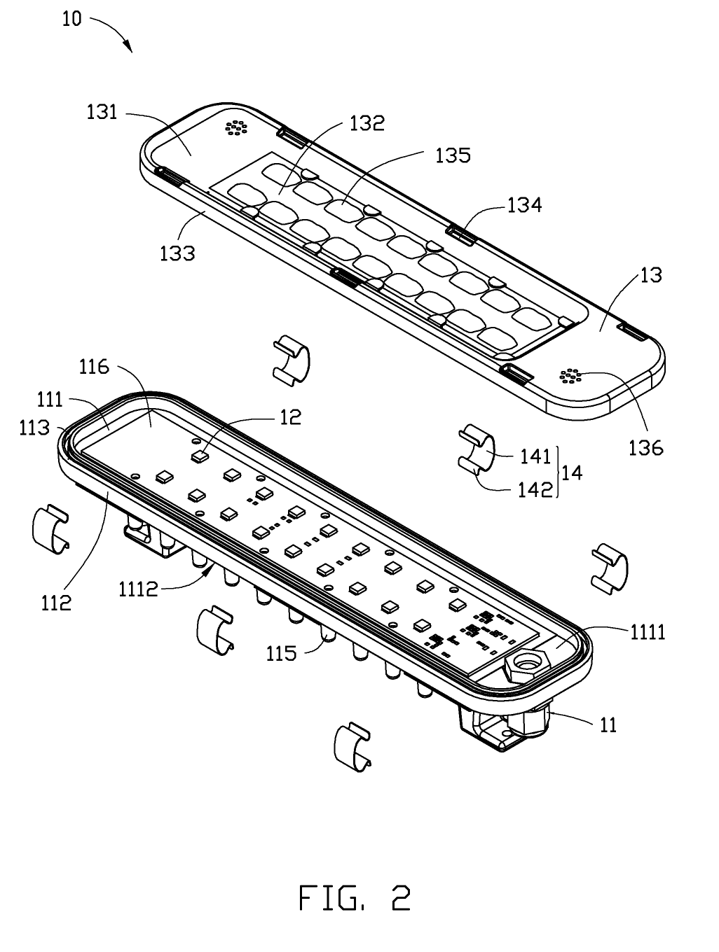

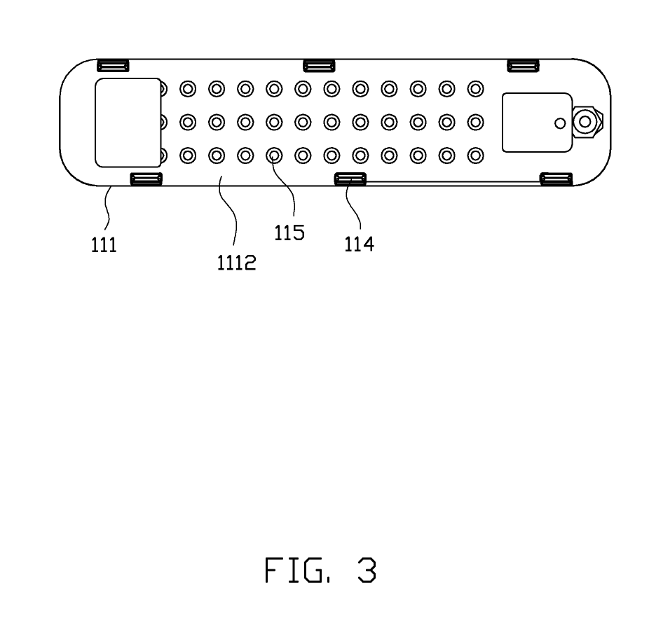

Referring to FIGS. 1 to 3, a light-emitting diode (LED) lamp 10 in accordance with a first embodiment of the present disclosure is shown. The LED lamp 10 comprises a supporting salver 11, a plurality of LEDs 12 mounted on the supporting salver 11, a lampshade 13 mounted on the supporting salver 11 and covering the plurality of LEDs 12, and a plurality of clips 14 detachably mounting the lampshade 13 on the supporting salver 11.

The supporting salver 11 is elongated and substantially rectangular. The supporting salver 11 comprises a supporting plate 111 and an annular sidewall 112 extending upwardly from an edge of the supporting plate 111. An annular receiving slot 113 is defined in a top of the sidewall 112. The supporting plate 111 comprises a first surface 1111 and a second surface 1112 opposite to each other. The sidewall 112 is formed on the first surface 1111 and encircling the plurality of LEDs 12. A plurality of heat dissipation members 115 extend downwardly from the second surface 1112 of the supporting plate 111. The supporting plate 111 defines a plurality of first recesses 114 in two opposite edges of the second surface 1112. Each of the plurality of first recesses 114 is strip-shaped along the edge of the second surface 1112.

The plurality of LEDs 12 are arranged on the first surface 1111 of the supporting plate 111 in array via a printed circuit board. Heat generating by each of the plurality of LEDs 12 is transferred to the supporting plate 111 and dissipated through the plurality of heat dissipating members 115. In this embodiment, the plurality of LEDs 12 are arranged in two rows along a length direction of the supporting salver 11.

The lampshade 13 is substantially rectangular. A shape of the lampshade 13 matches that of the supporting plate 111. The lampshade 13 comprises a rectangular main body 131, an optic portion 132 at a middle portion of the main body 131 and an annular flange 133 formed at an edge of the main body 131. The main body 131 defines a plurality of ventilation holes 136 in two opposite end portions thereof. The plurality of ventilation holes 136 runs through the main body 131 for heat dissipation and ventilation. The lampshade 13 further defines a plurality of second recesses 134 in two opposite edges of a top surface corresponding to the plurality of first recesses 114 of the supporting salver 11. Each of the plurality of second recesses 134 of the lampshade 13 is strip-shaped and aligned with each of the plurality of first recesses 114 of the supporting salver 11. The lampshade 13 also acts as a dustproof cover for the plurality of LEDs 12.

Each of the plurality of clips 14 is substantially C-shaped and formed through bending a metal strip integrally. In other embodiment, the clip can be made in resilient plastic materials, such as polyvinyl chloride (PVC), et al. Each of the plurality of clips 14 comprises a curved connecting portion 141 and two buckling portions 142 formed at two opposite ends of the connecting portion 141. Each of the two buckling portions 142 is V-shaped. The two buckling portions 142 face each other with their pointed portions. A distance between the two bucking portions 142 is less than a sum of thicknesses of the supporting salver 11 and the lampshade 13 when the plurality of clips are 14 in natural states without deformation. The connecting portion 141 and the two buckling portions 142 are resilient. The distance between the two buckling portions 142 is adjustable via resilient deformation of the connecting portion 141.

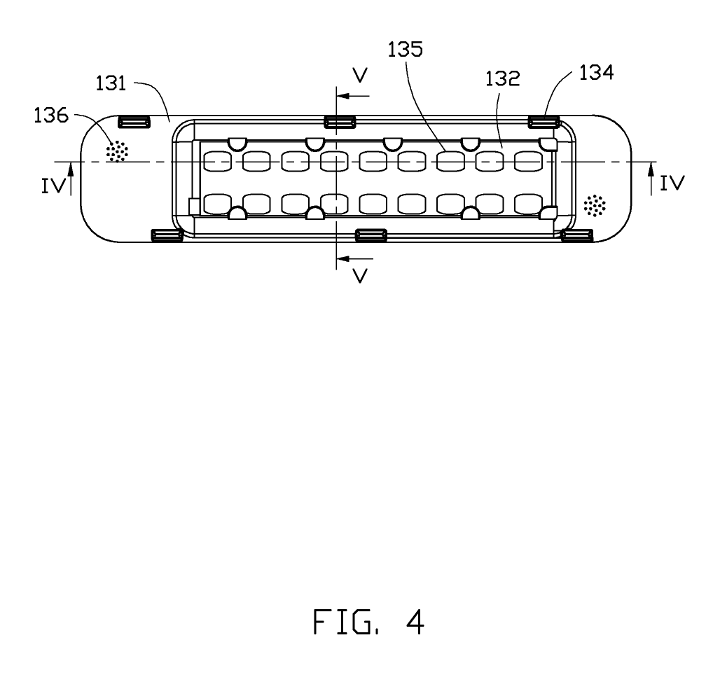

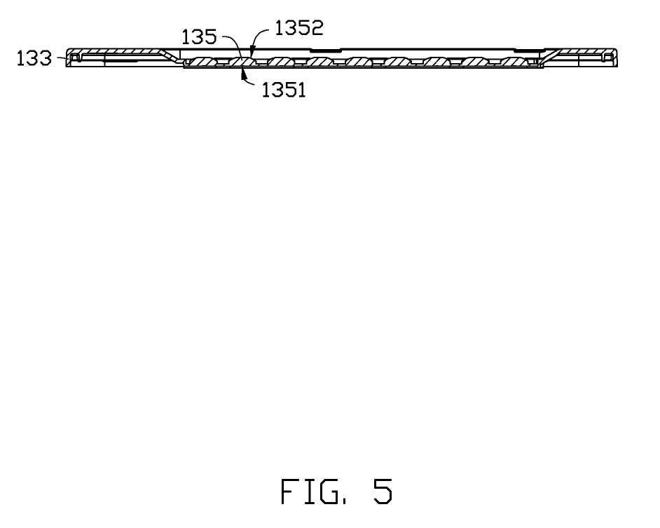

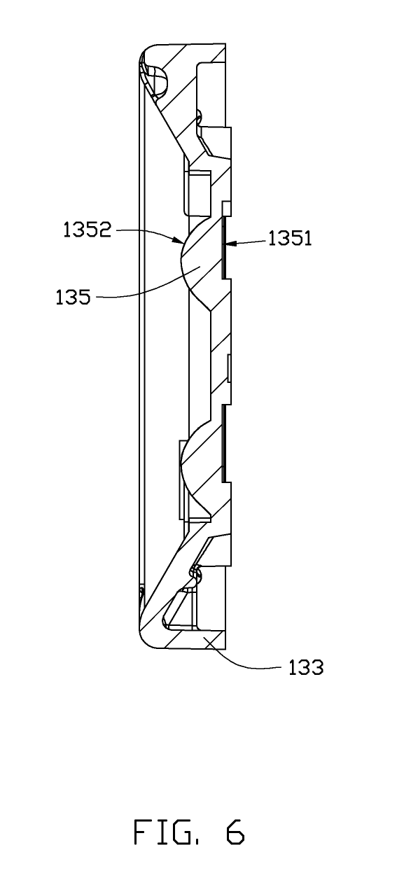

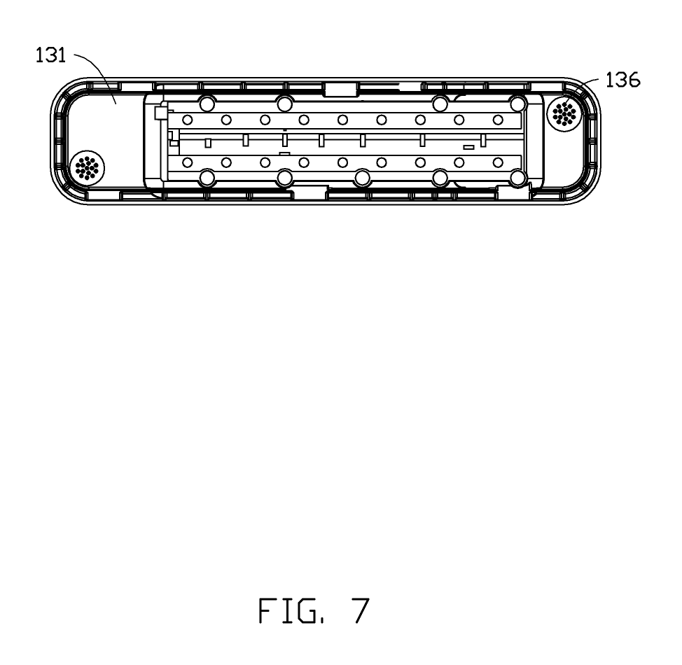

Referring to FIGS. 4 to 7, the optic portion 132 comprises a plurality of lenses 135 formed thereon for adjusting light distribution of the plurality of LEDs 12. The plurality of lenses 135 are arranged in an array, in this embodiment the plurality of lens 135 are arranged in two rows along a length direction of the lampshade 13. Each of the plurality of lenses 135 is aligned with one of the plurality of LEDs 12. The lampshade 13 is formed integrally through mold injection. In other embodiment, the lampshade 13 also can be formed through thermosetting molding, i.e. a material of the lampshade 13 is heated up and simultaneously pressed to form an accurate optic portion 132.

Each of the plurality of lenses 135 comprises a light receiving surface 1351 and a light output surface 1352 opposite to each other. Light emitted by the plurality of LEDs 12 radiates into the plurality of lens 135 through the light receiving surface 1351 and radiates out of the plurality of lens 135 through the light output surface 1352. The light of the plurality of LEDs 12 is refracted at the light output surface 1352, and thus the light distribution of the plurality of LEDs 12 is changed. The light receiving surface 1351 is flat and positioned at the level adjacent to a bottom surface of the optic portion 132. The light-output surface 1352 protrudes out of a top surface of the optic portion 132 convexly. A maximum thickness of each of the plurality of lens 135 between the light receiving surface 1351 and the light output surface 1352 is half as a height of the flange 133. An orthographic projection of the plurality of lens 135 on the supporting plate 111 is substantially elliptical. Cross sections of the plurality of lens 135 respectively along length and width directions thereof are both arch-shaped.

In assembly of the LED lamp 10, the lampshade 13 is placed on the supporting salver 11 with the flange 133 thereof received in the receiving slot 113. By this stage, each of the plurality of second recesses 134 of the lampshade 13 is aligned with each of the plurality of first recesses 114 of the supporting salver 11. Each of the plurality of clips 14 is pushed towards the lampshade 13 and the supporting salver 11 from a lateral side of the lampshade 13 and the supporting salver 11 until one of the two buckling portions 142 of each of the plurality of clips 14 is received in each of the plurality of first recesses 114 of the supporting salver 11 and the other one of the two buckling portion 142 is received in corresponding one of the plurality of second recesses 134 of the lampshade 13, thus mounting the supporting salver 11 and the lampshade 13 with each other in a dismountable way. Since the connecting portion 141 and the two buckling portions 142 are resilient, the plurality of clips 14 can be easily pulled out of the pluralities of first and second recesses 114, 134 of the supporting salver 11 and the lampshade 13, thus detaching the lampshade 13 and the supporting salver 11 from each other. This facilitates replacement of the lampshade 13.

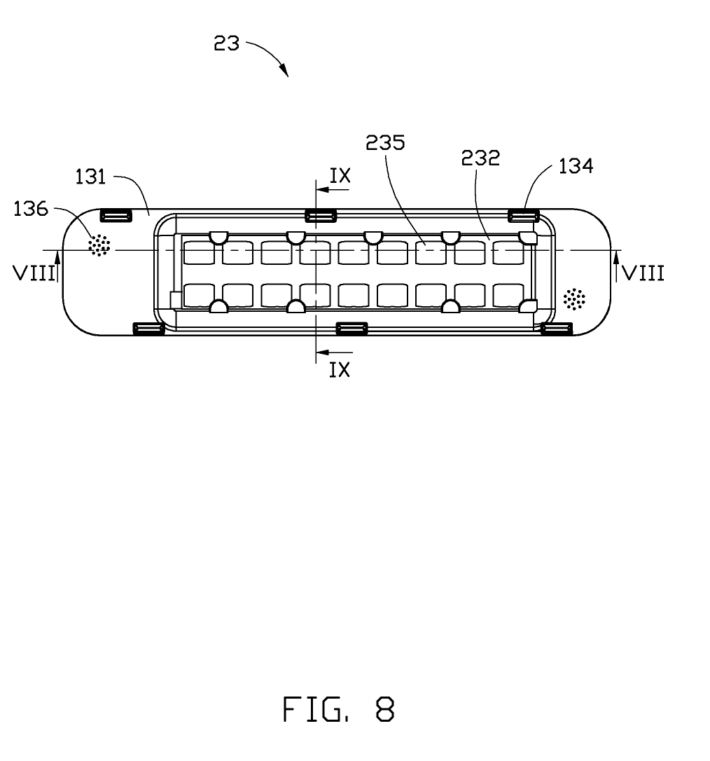

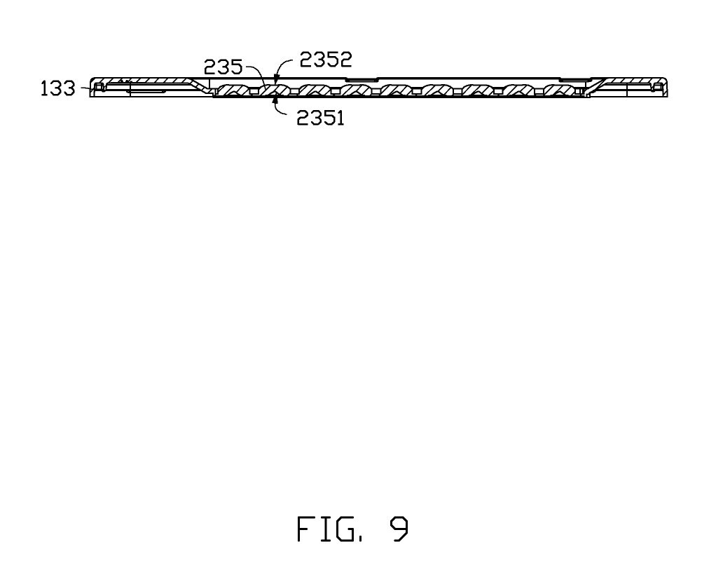

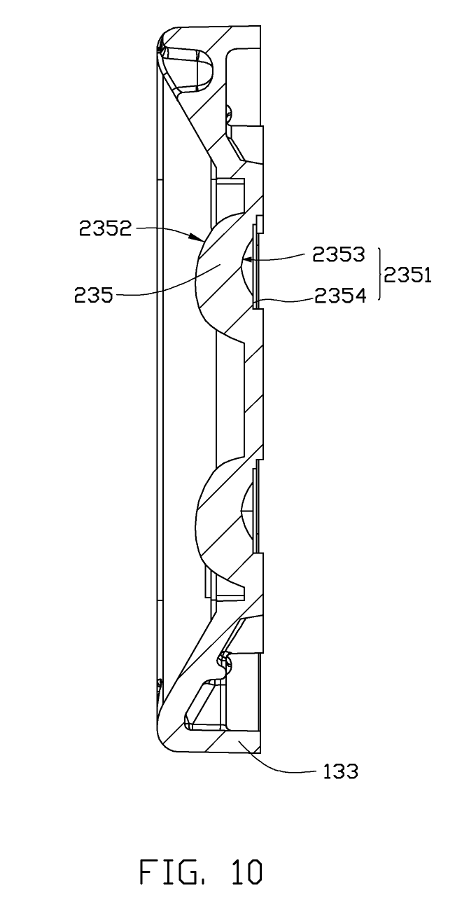

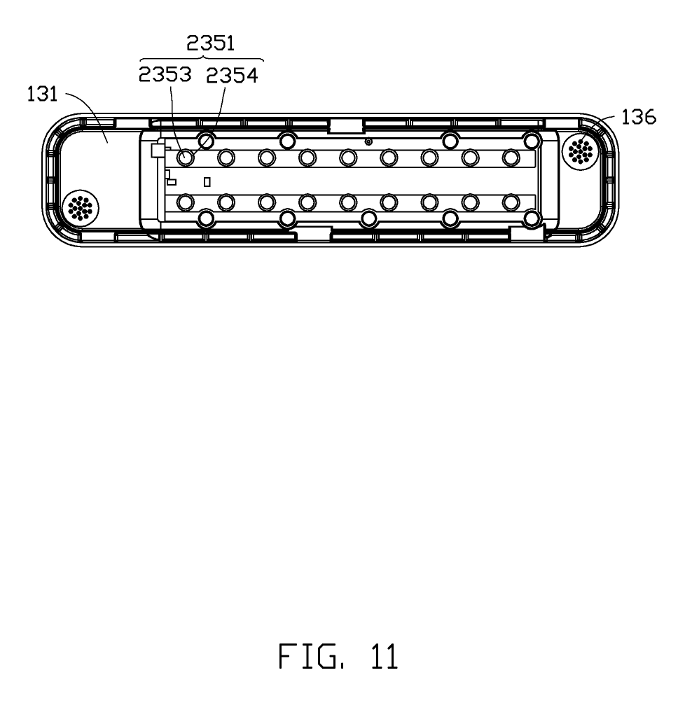

FIGS. 8 to 11 present a lampshade 23 of an LED lamp in accordance with a second embodiment of the present disclosure. The lampshade 23 is similar to that of the first embodiment but differs from that of the first embodiment in optic portion 232. The optic portion 232 of the lampshade 23 comprises a plurality of lenses 235 arranged in an array. Each of the plurality of lenses 235 comprises a light receiving surface 2351 and a light output surface 2352 opposite to each other. The light receiving surface 2351 comprises a concave portion 2353 depressed in a middle portion thereof and an annular flat portion 2354 surrounding the concave portion 2353. A cross section of the concave portion 2353 is arch-shaped. The light output surface 2352 is convex. The concave portion 2353 faces the plurality of LEDs 12. An orthographic projection of each of the plurality of lenses 235 on the supporting plate 111 is substantially rectangular. Cross sections of each of the plurality of lenses 235 respectively along length and width directions of the optic portion 232 are both arch-shaped.

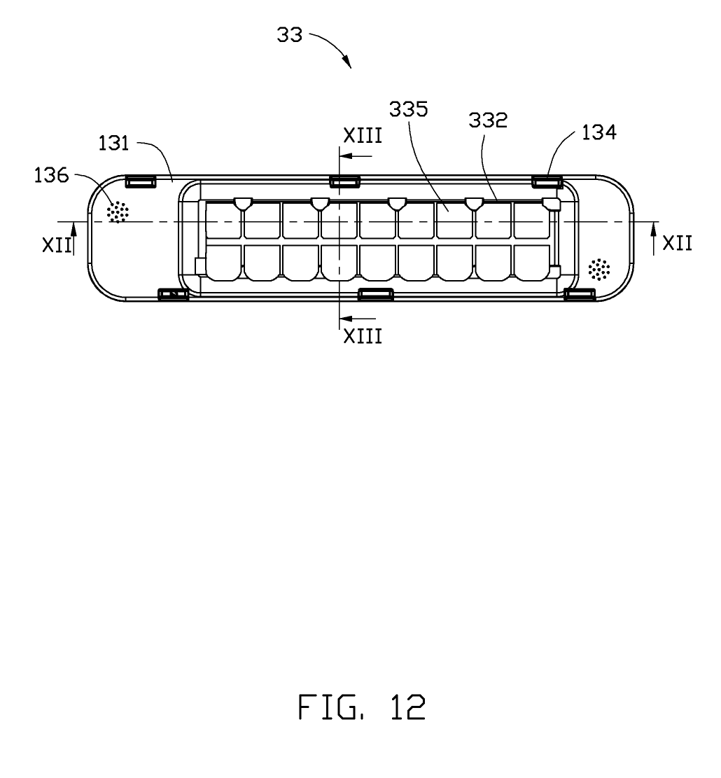

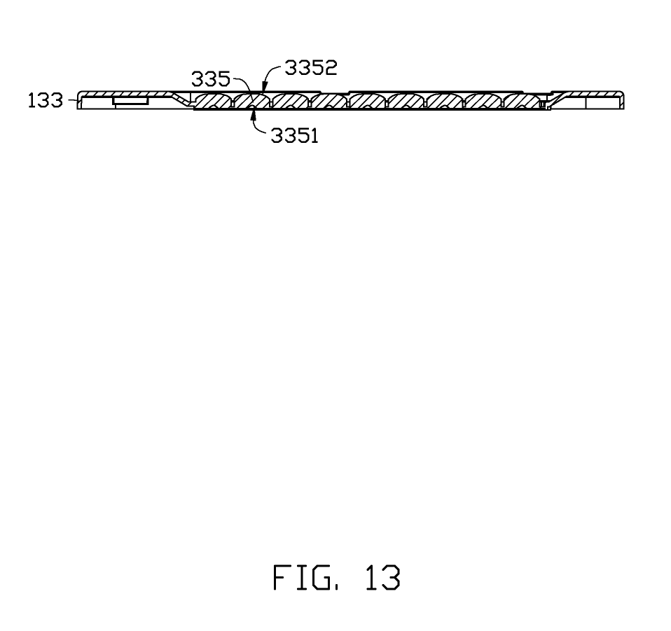

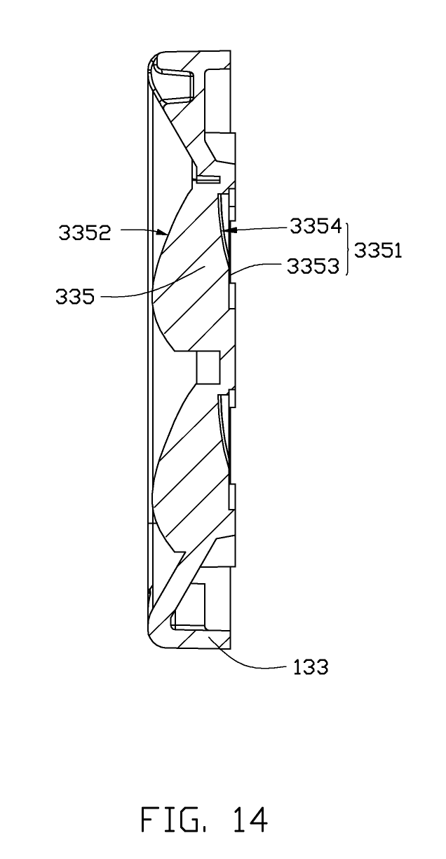

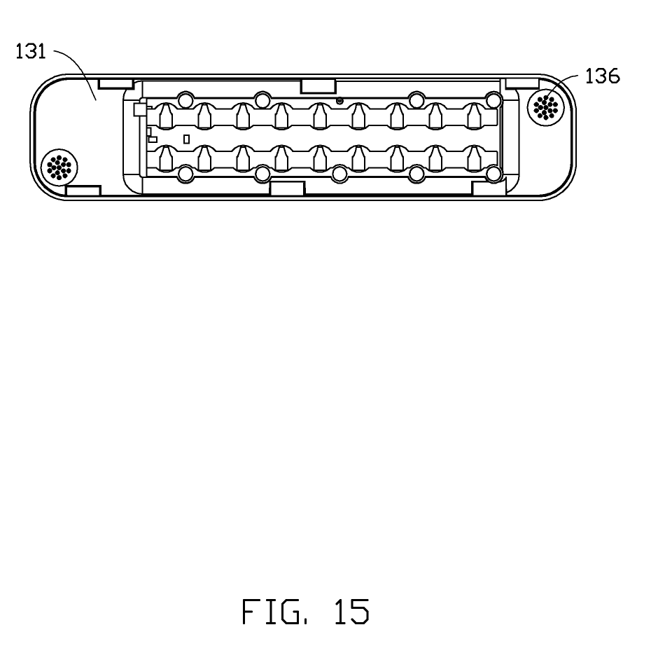

FIGS. 12 to 15 present a lampshade 33 of an LED lamp in accordance with a third embodiment of the present disclosure. The lampshade 33 is similar to that of the first embodiment but differs from that of the first embodiment in optic portion 332. The optic portion 332 of the lampshade 33 comprises a plurality of lenses 335 arranged in array. Each of the plurality of lenses 335 is drip-shaped and comprises a light receiving surface 3351 and a light output surface 3352 opposite to each other. The light receiving surface 3351 comprises a flat surface 3353 at one side thereof and a slantwise surface 3354 depressed in each of the plurality of lenses 335 slantways from an edge of the flat surface 3353 towards an opposite side thereof. The light output surface 3352 is convex. An orthographic projection of each of the plurality of lenses 335 on the supporting plate 111 is substantially rectangular. A cross section of each of the plurality of lenses 335 along a length direction of the lampshade 33 is arch-shaped. A cross section of each of the plurality of lens 335 along a width direction of the lampshade 33 is drip-shaped.

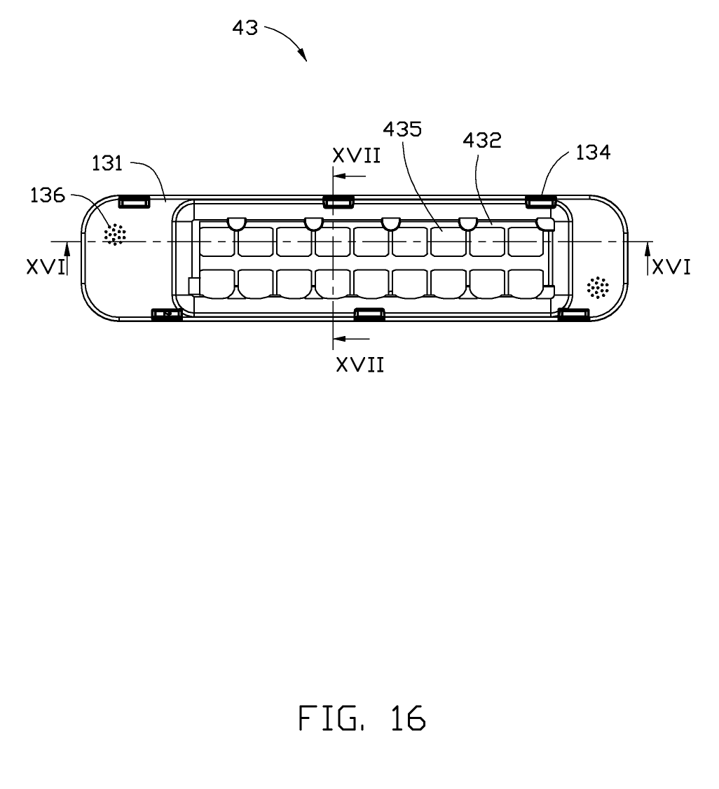

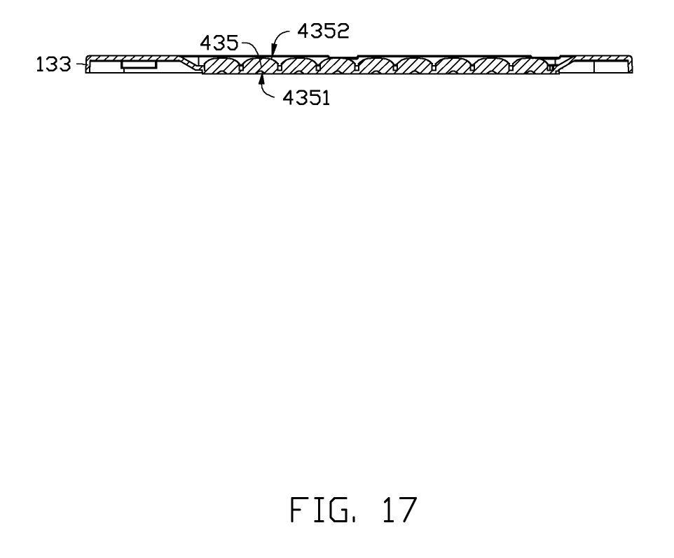

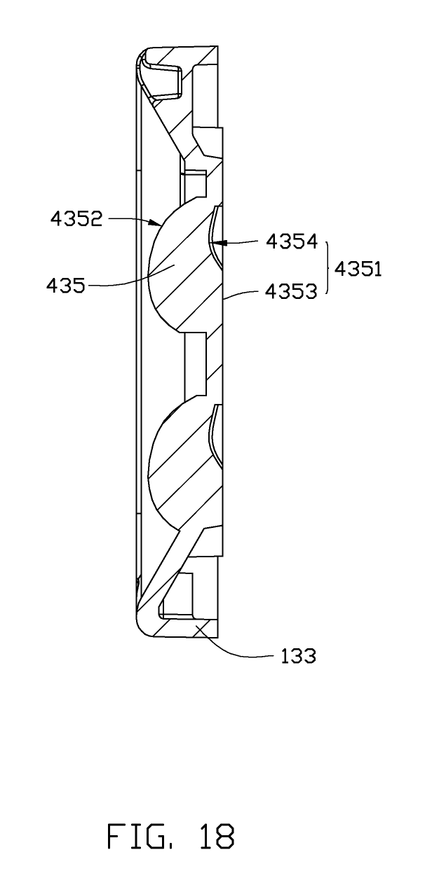

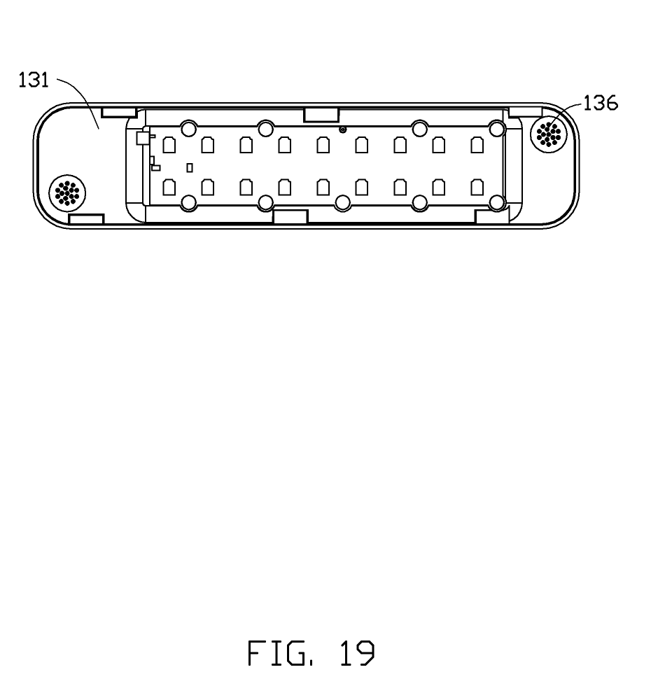

FIGS. 16 to 19 present a lampshade 43 of an LED lamp in accordance with a fourth embodiment of the present disclosure. The lampshade 43 is similar to that of the first embodiment but differs from that of the first embodiment in optic portion 432. The optic portion 432 of the lampshade 43 comprises a plurality of lenses 435 arranged in array. Each of the plurality of lenses 435 comprises a light receiving surface 4351 and a light output surface 4352 opposite to each other. The light receiving surface 4351 comprises a flat surface 4353 at one side thereof and a concave surface 4354 depressed in each of the plurality of lenses 435 slantways from an edge of the flat surface 4353 towards an opposite side thereof. The light output surface 4352 is convex. A curvature of the concave surface 4354 is equal to that of the light output surface 4352. An orthographic projection of each of the plurality of lenses 435 on the supporting plate 111 is substantially rectangular. A cross section of each of the plurality of lenses 435 along a length direction of the lampshade 43 is arch-shaped.

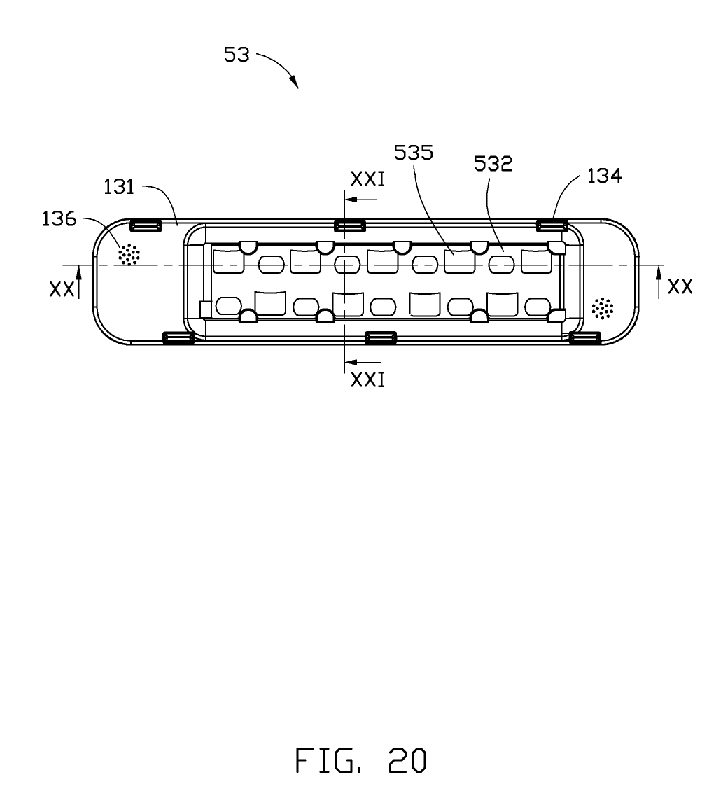

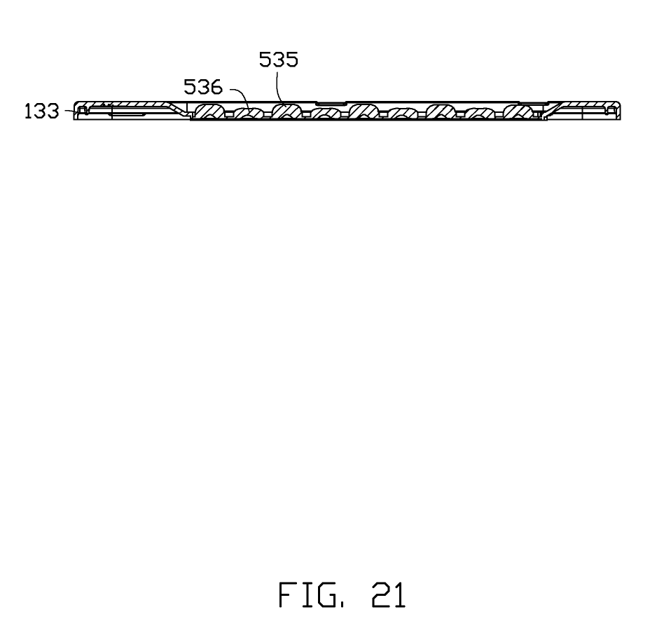

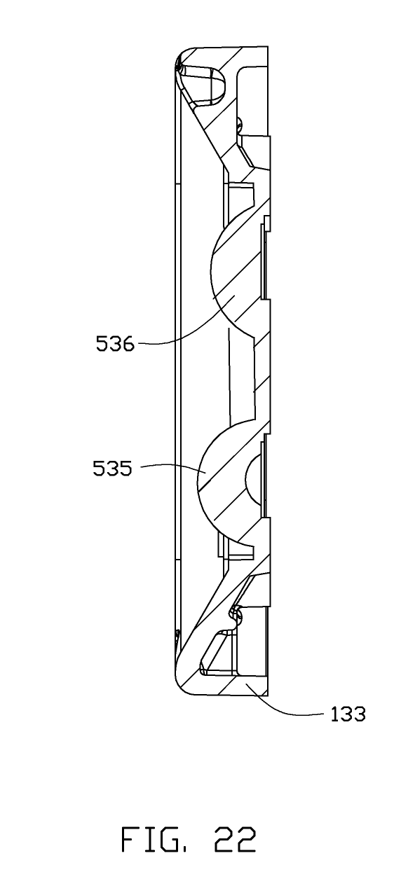

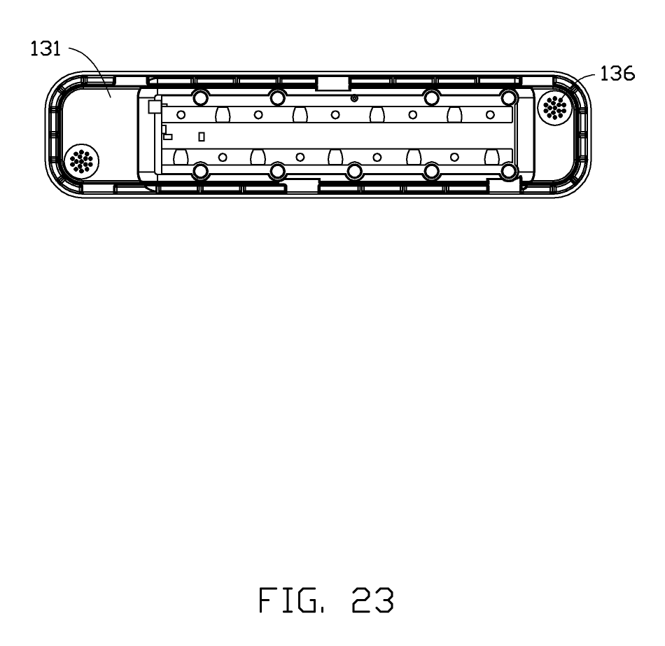

FIGS. 20 to 23 present a lampshade 54 of an LED lamp in accordance with a fifth embodiment of the present disclosure. The lampshade 54 is similar with that of the first embodiment but differs from that of the first embodiment in an optic portion 532. The optic portion 532 comprises a plurality of first lenses 535 and a plurality of second lenses 536. The plurality of first lenses 535 and the plurality of second lenses 536 are staggered in rows and columns. The plurality of first lenses 535 are identical to that of the second embodiment. The plurality of second lenses 536 are identical to that of the first embodiment.

In the aforementioned embodiment, since the lampshade 13, 23, 33, 43, 53 are mounted on the supporting salver 11 in a dismountable way through the plurality of clips 14 and each of the lampshade 13, 23, 33, 43, 53 has a different optic portion 132, 232, 332, 432, 532, the LED lamp 10 can change different lampshades 13, 23, 33, 43, 53 conveniently to generate different light distributions to meet different light distribution requirements without redesigns of the LED lamp. Therefore, waste is avoided.

It is to be understood, however, that even though numerous characteristics and advantages of the exemplary embodiments have been set forth in the foregoing description, together with details of the structures and functions of the embodiments, the disclosure is illustrative only; and that changes may be made in detail, especially in matters of shape, size, and arrangement of parts within the principles of the embodiments to the full extent indicated by the broad general meaning of the terms in which the appended claims are expressed.

What is claimed is:

1. A light-emitting diode lamp comprising:
a supporting salver comprising a first surface and a second surface opposite to the first surface, wherein the second surface defines a plurality of first recesses therein;
a plurality of light-emitting diodes mounted on the first surface of the supporting salver;
a lampshade covering the plurality of light-emitting diodes for changing light distribution of the plurality of light-emitting diodes, the lampshade comprising an optic portion facing the plurality of light-emitting diodes, the optic portion comprising a plurality of lenses formed thereon, each of the plurality of lenses facing each of the plurality of light-emitting diodes, the lampshade defining a plurality of second recesses therein corresponding to the plurality of first recesses of the supporting salver, each of the plurality of first recesses aligned with each of the plurality of second recesses; and
a plurality of clips each comprising a connecting portion and two buckling portions formed at two opposite ends of the connecting portion, the connecting portion being resilient, one of the two buckling portions being received in one of the plurality of first recesses, another one of the two buckling portions being received in a corresponding one of the plurality of second recesses, wherein
the lampshade is interchangeably mounted on the supporting salver through the plurality of clips.

2. The light-emitting diode lamp of claim 1, wherein each of the two buckling portion is a V-shape and resilient, and the two buckling portions of each of the plurality of clips are oriented opposite to each other with a point of the V-shape facing each other.

3. The light-emitting diode lamp of claim 2, wherein an annular sidewall is provided on the supporting salver, the annular sidewall defines an annular receiving slot in a top thereof, the lampshade comprises a main body and an annular flange formed at an edge of the main body, the optic portion is located at a middle portion of the main body, and the annular flange is received in the annular receiving slot.

4. The light-emitting diode lamp of claim 3, wherein the main body defines a plurality of ventilation holes in two opposite end portions thereof, the plurality of ventilation holes run through the main body and are configured for heat dissipation and ventilation.

5. The light-emitting diode lamp of claim 2, wherein the plurality of lenses are arranged in an array, each of the plurality of lenses comprises a light receiving surface and a light output surface opposite to the light receiving surface, the light receiving surface of each of the plurality of lens faces a corresponding one of the plurality of light-emitting diodes; wherein the plurality of lenses are configure to transmit light from each of the plurality of light-emitting diodes into the light receiving surface, radiate out of each of the plurality of lenses through the light output surface, and refract the light at the light output surface.

6. The light-emitting diode lamp of claim 5, wherein the light receiving surface of each of the plurality of lenses is flat, the light output surface protrudes out of the optic portion convexly, an orthographic projection of each of the plurality of lenses on the supporting salver is elliptical, and cross sections of each of the plurality of lenses along a length direction and a width direction of the optic portion are both arch-shaped.

7. The light-emitting diode lamp of claim 5, wherein the light receiving surface comprises a concave portion depressed in a middle portion thereof and an annular portion surrounding the concave portion, a cross section of the concave portion is arch-shaped and the annular portion is flat, an orthographic projection of each of the plurality of lens on the supporting salver is rectangular, and cross sections of each of the plurality of lens along a length direction and a width direction of the optic portion are both arch-shaped.

8. The light-emitting diode lamp of claim 5, wherein each of the plurality of lens is drip-shaped, the light receiving surface comprises a flat surface at one side thereof and a slantwise surface depressed slantways from an edge of the flat surface towards an opposite side thereof, the light output surface is convex, an orthographic projection of each of the plurality of lenses on the supporting salver is rectangular, a cross section of each of the plurality of lenses along a length direction of the lampshade is arch-shaped, and a cross section of each of the plurality of lens along a width direction of the lampshade is drip-shaped.

9. The light-emitting diode lamp of claim 5, wherein the light receiving surface comprises a flat surface at one side thereof and a concave surface depressed slantways from an edge of the flat surface towards an opposite side thereof, the light output surface is convex, a curvature of the concave surface is equal to a curvature of the light output surface, an orthographic projection of each of the plurality of lenses on the supporting salver is rectangular, and a cross section of each of the plurality of lenses along a length direction of the lampshade is arch-shaped.

10. The light-emitting diode lamp of claim 5, wherein each of the plurality of lenses comprises a plurality of first lenses and a plurality of second lens different from each other, the plurality of first lenses and the plurality of second lenses are staggered in rows and columns.

11. The light-emitting diode lamp of claim 10, wherein a light receiving surface of each of the plurality of first lenses comprises a concave portion depressed in a middle portion thereof and an annular portion surrounding the concave portion, a cross section of the concave portion is arch-shaped and the annular portion is flat, an orthographic projection of each of the plurality of first lenses on the supporting salver is rectangular, and cross sections of each of the plurality of first lenses along a length direction and a width direction of the optic portion are both arch-shaped, a light receiving surface of each of the plurality of second lenses is flat, a light-output surface of each of the plurality of second lenses protrudes out of the optic portion convexly, an orthographic projection of each of the plurality of second lenses on the supporting salver is elliptical, and cross sections of each of the plurality of second lenses along a length direction and a width direction oft eh optic portion are both arch-shaped.

12. The light-emitting diode lamp of claim 10, wherein the lampshade is formed integrally through mold injection or thermosetting molding.

13. The light-emitting diode lamp of claim 2, wherein the clip plurality of clips are made of metal or plastic.

14. The light-emitting diode lamp of claim 1, wherein a plurality of heat dissipating members are formed on the second surface of the salver.

15. A light-emitting diode lamp comprising:
a supporting salver defining a first recess therein;
a lampshade coupled to the supporting salver, the lampshade defining a second recess aligned with the first recess
an LED mounted on the supporting salver and covered by the lampshade; and
a clip mounting the lampshade on the supporting salver in a dismountable way, the clip comprising two buckling portions and a connecting portions interconnecting the tow buckling portions; wherein one of the two buckling portions is engaged in the first recess of the supporting salver, another one of the two buckling portions is engaged with the second recess of the lampshade, the connecting portion is resilient, and wherein
a distance between the two buckling portions is enlarged when the connecting portion is deformed to couple the lampshade to the supporting salver through the clip.
